(19) United States
(12) Patent Application Publication
(10) Pub. No.: US 2006/0240316 A1
(43) Pub. Date: Oct. 26, 2006

(54) Battery retainer

(76) Inventor: John R. Martinez, Murrieta, CA (US)

Correspondence Address: FISH & RICHARDSON P.C., P.O. BOX 1022, MINNEAPOLIS, MN, 55440-1022, US

(21) Appl. No.: 11/114,887

(22) Filed: Apr. 26, 2005

(51) Int. Cl. H01M 2/10

(52) U.S. Cl. 429/97; 429/100

(57) ABSTRACT

A frame defines a battery receiving compartment. A conductive surface is exposed on the frame and is adapted to electrically contact a terminal of a battery inside the frame. A conductive arm is movably coupled to the frame and electrically coupled to the conductive surface. A conductive pad is positioned proximate the conductive arm. The conductive arm is movable in such a manner as to electrically contact the conductive pad, when so urged.

### FIELD

This disclosure relates to battery retainers.

### BACKGROUND

Batteries are used to power a wide range of portable devices. Typically, such devices include a battery retaining compartment built therein. Particular battery retaining compartment designs may vary to accommodate various numbers, sizes and arrangements of batteries. Such battery retaining compartments typically include internal conductors exposed for coupling to appropriate terminals of the batteries positioned therein.

### SUMMARY

In one aspect, an apparatus includes a frame that defines a battery receiving compartment, a conductive surface exposed on the frame to electrically contact a terminal of a battery in the frame, a conductive arm that is movably coupled to the frame and electrically coupled to the conductive surface and a conductive pad positioned proximate the conductive arm. The conductive arm is movable in such a manner as to electrically contact the conductive pad, when so urged.

In some implementations, the conductive arm is flexibly coupled to the frame and adapted to flex to a position to electrically contact the conductive pad.

Certain embodiments include a support pad positioned below the frame. The frame may be coupled to the support pad. The support pad may be positioned in a same plane as the conductive pad. The support pad may be coupled to the substrate. The substrate may be a flexible circuit board and the support pad may be substantially rigid relative to the flexible circuit board. The support pad may be adapted to provide rigidity to a portion of the flexible circuit board that is substantially surrounded by the support pad. A conductive connection point may be exposed on a surface of the substrate beneath the battery holding compartment. The conductive connection point may be adapted to mate with a terminal of a battery that is positioned inside the battery holding compartment. The support pad may define a circuit mounting area on the substrate in an area of the substrate that is substantially surrounded by the support pad. The battery holding compartment may be located substantially above the circuit mounting area. A plurality of circuit elements may be coupled to the substrate in the circuit mounting area. The support pad may form a pattern that approximates a pattern defined by a footprint of the frame.

Certain implementations include a frame that is a conductive material. In that instance, the conductive arm may be electrically coupled to the conductive surface exposed on the frame to electrically contact a terminal of a battery in the frame through the conductive frame. In some embodiments, the conductive arm may extend from the frame in a direction that is substantially away from the battery holding compartment.

Some implementations include a frame that includes a substantially flat base, a side wall that extends from portions of the base in a direction that is substantially perpendicular to a plane of the base and an overhead coupled to portions of the side wall. The overhead may extend from portions of the side wall to partially or completely cover the battery compartment. The base may have a base footprint that, when the frame is coupled to a substrate, substantially surrounds a circuit mounting area on a surface of the substrate. The circuit mounting area, when the frame is coupled to the substrate, may be located beneath the battery holding compartment. A pair of substantially parallel support elements may extend from the base in a direction substantially away from the battery receiving compartment. The conductive arm may be movable so that a distal end of the conductive arm is between the pair of substantially parallel support elements, when so urged.

The side wall of the frame may define a side wall of the battery holding compartment. The side wall of the frame also may include surfaces that define a battery insertion aperture adapted to facilitate insertion of a battery into the battery holding compartment.

The conductive arm may extend from a portion of the overhead. Also, a battery retaining tab may extend from a portion of the overhead into the battery holding compartment. The battery retaining tab may be flexibly coupled to the overhead portion of the frame. The battery retaining tab may be adapted to contact an upper surface of a battery in the battery holding compartment. The battery retaining tab may be adapted to electrically contact a terminal of a battery positioned inside the battery holding compartment. The battery retaining tab also may be adapted to physically contact a battery in the battery holding compartment and urge the battery in a substantially downward direction.

In some instances, multiple battery retaining tabs are coupled to the frame. In such instances, each battery retaining tab may extend from a respective portion of the overhead element at least partially into the battery holding compartment. Additionally, each battery retaining tab may extend in a direction that is parallel to another one of the battery retaining tabs.

According to some implementations, the apparatus includes multiple conductive arms coupled to the frame and multiple conductor pads. In such instances, each conductive pad may be exposed at a position near an associated one of the conductive arms. Additionally, each conductive arm's position may be independently adjustable to electrically contact an associated one of the conductive pads.

In another aspect, an apparatus includes a flexible substrate and a frame coupled to the flexible substrate. The frame defines a battery holding compartment. A plurality of circuit elements are coupled to the flexible substrate beneath the battery holding compartment. The plurality of circuit elements includes a conductive connection point exposed at a position above the flexible substrate that is higher than the other circuit elements.

In certain embodiments, the conductive connection point extends at least partially into the battery holding compartment to electrically contact a terminal of a battery inside the battery holding compartment.

According to some implementations, the frame is rigid relative to the flexible substrate.

In some instances, a support pad is positioned between the frame and the flexible substrate. The support pad may be rigid relative to the flexible substrate. The plurality of circuit elements can be coupled to an area of the flexible substrate that is substantially surrounded by the support pad.

In some implementations, one or more of the following advantages may be present. Circuit devices incorporating the techniques and apparatuses disclosed herein may be made smaller, simpler and less expensive. For example, such circuit devices may no longer require the space, cost or complexity associated with including both a traditional battery compartment and separate switching elements into the device. Additionally, such a circuit device may be made smaller by virtue of the fact that the circuit elements may be positioned below the battery holding compartment. Accordingly, in certain implementations, the area outside the battery holding compartment that is required to house circuit elements on a circuit board may be minimized. As a result, less material may be needed to manufacture such circuit devices, thereby resulting in a lower manufacturing cost. Additionally, a circuit device that incorporates the techniques disclosed herein can be simple to operate.

Other features or advantages will be apparent from the following description, drawings and claims.

### BRIEF DESCRIPTION OF THE DRAWINGS

FIGS. 1A and 1B are plan views of a patch assembly with a battery retainer.

FIG. 2 is an exploded view of a patch assembly with a battery retainer.

FIGS. 3A and 3B are detail views of a battery retainer.

Like reference symbols in the various drawings indicate like elements.

### DETAILED DESCRIPTION

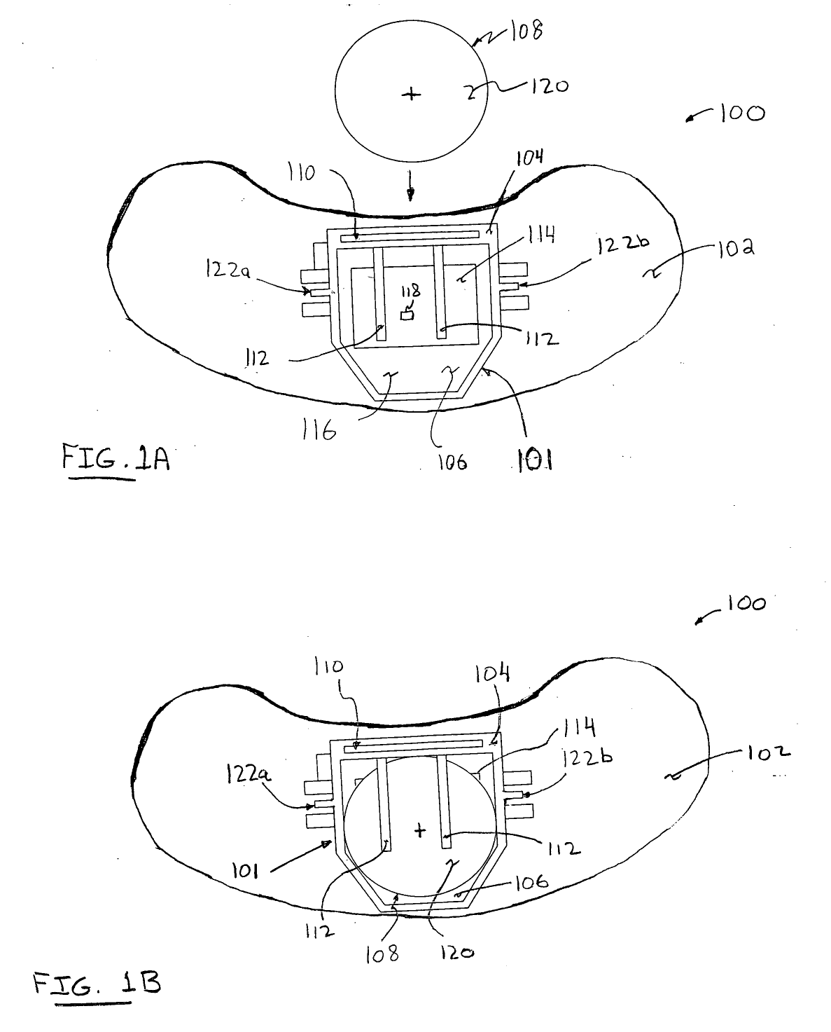

FIGS. 1A and 1B illustrate a patch assembly 100 that may be adhesively attached to the skin of a patient in need of pulsed electromagnetic field (PEMF) therapy. The patch assembly 100 is a self-contained, portable device adapted to conveniently deliver PEMF therapy to the patient. Typically, the patch assembly 100 includes an electromagnetic field generator, an antenna coupled to the generator and arranged to radiate the electromagnetic field and a battery 108 adapted to power the electromagnetic field generator. An example of a portable PEMF therapy patch assembly was disclosed in U.S. application Ser. No. 10/442,448, entitled Electromagnetic Therapy Device and Methods, filed May 21, 2003, which is hereby incorporated by reference in its entirety.

According to the illustrated implementation, the patch assembly 100 includes a substrate 102 that typically would be a flexible circuit board. A battery retainer 101 includes a frame 104 that is coupled to the substrate 102. The frame is typically a rigid material relative to the substrate 102 material. The frame 104 defines a battery holding compartment 106 therein. A battery insertion aperture 110 is formed in a side surface of the frame 104. A battery 108 can be inserted into the battery holding compartment 106 through the battery insertion aperture 110.

As illustrated, multiple circuit elements 114 (indicated by the box labeled 114) populate a circuit mounting area 116 of the substrate 102. The circuit elements 114 may include, for example, a variety of active and passive electronic components, as well as various conductive elements connecting those components. The circuit mounting area 116 may be defined as that portion of the substrate's 102 surface that is substantially enclosed by the frame 104 and/or its support elements (not shown). Since the frame 104 is more rigid than the underlying substrate 102, and since the frame 104 is securely coupled to the substrate 102, the circuit mounting area 116 on the substrate's 102 surface possesses greater structural rigidity than other areas of the substrate 102 outside the circuit mounting area 116. As illustrated, the circuit mounting area 116 of the substrate 102 surface is located beneath the battery holding compartment 106.

The circuit elements 114 include a conductive connection point 118 exposed on a surface of the substrate 102 within the circuit mounting area 116 and beneath the battery holding compartment 106. The conductive connection point 118 is adapted to electrically mate with a terminal of a battery (e.g., battery 108) positioned inside the battery holding compartment 106. The conductive connection point 118 is electrically coupled to at least one of the circuit elements 114 mounted in the circuit mounting area 116. The conductive connection point 118 extends above an upper surface of the substrate 102 a distance higher than any of the other circuit elements 114 mounted in the circuit mounting area 116. With such an arrangement, a terminal on a lower surface of a battery 108 positioned within the battery holding compartment 116 can contact the conductive connection point 118.

The frame 104 includes a pair of battery retaining tabs 112 that extends from one side of the frame 104 at least partially into the battery holding compartment 106. The battery retaining tabs 112 extend from the same surface of the frame 104 and extend approximately parallel to each other. The battery retaining tabs 112 are flexibly coupled to the side of the frame 104. More specifically, the pair of battery retaining tabs 112 are adapted to flex relative to the frame in an upward direction when the battery 108 is slid into the battery holding compartment 116. Accordingly, the battery retaining tabs 112 are adapted to flex to accommodate circuit elements 114 and batteries 108 that have various heights above the substrate 102 material. For example, if the combined height of the circuit elements 114 (including the conductive connection point 118) and the battery 108 is low, the distal ends of the battery retaining tabs 112 that contact an upper surface of the battery 108 may be lower than if the combined height were higher.

Referring now to FIG. 1B, with a battery 108 positioned inside the battery holding compartment 106, a distal end of the battery retaining tabs 112 contacts an upper surface of the battery 108 and applies a downward force against the upper surface 120 of the battery 108 urging the battery 108 toward the substrate 102. That downward force may facilitate maintaining a favorable electrical connection between the exposed conductive connection point 118 on the substrate 102 and a terminal on the lower surface (opposite 120) of the battery 108. In certain embodiments, other parts of the battery retaining tabs 112 (i.e. other than the distal ends) may be adapted to contact the upper surface 120 of a battery 108 positioned within the battery holding compartment 116.

According to the illustrated implementation, conductive arms 122a and 122b extend outward from the frame 104 from opposite sides of the frame 104 and in opposite directions. Each conductive arm 122a and 122b is flexibly coupled to the frame 104 and is adjustably positionable by virtue of its flexible coupling. In a relaxed state, a distal end of each conductive arm 122a and 122b is raised above an associated conductive pad (not shown) exposed on the substrate 102 beneath the distal end. Each conductive arm 122a and 122b can be bent downward, upon application of an appropriate force, so that the distal end of the conductive arm 122a and 122b contacts its associated conductive pad (not shown).

The conductive arms 122a and 122b may coupled to the frame 104 in any manner that facilitates adjustable positioning of the conductive arms in the manner outlined above. For example, the conductive arms 122a and 122b may be flexibly coupled, hingedly coupled, or otherwise coupled to the frame 104, so long as it is movable relative to the frame 104 in a direction so as to contact an associated conductive pad.

According to the illustrated embodiment, the upper surface 120 of the battery 108 is a positive terminal and a lower surface (opposite 120) of the battery 108 is a negative terminal. In FIG. 1B, the positive terminal of the battery 108 is electrically coupled to each conductive arm 122a and 122b. That electrical coupling may be implemented in a number of possible ways. For example, when a battery 108 is positioned inside the battery holding compartment, the positive terminal 120 of the battery 108 may contact one or more conductive surfaces of the frame 104. Those conductive surfaces may include, for example, conductive portions of the frame 104 or conductive portions of the battery retaining tabs 112. Such coupling may be achieved either directly through the frame 104 or may involve cooperation of other conductive elements (not shown). When a distal end of a conductive arm 122a or 122b contacts an associated conductive pad (not shown) on the substrate 102 surface, an electrical circuit is completed between the positive terminal of the battery 108 and the negative terminal of the battery 108.

In some implementations, each conductive pad (not shown) that is exposed on a surface of the substrate 102 is coupled to at least one of the circuit elements 114 mounted in the circuit mounting area 116 on the substrate 102.

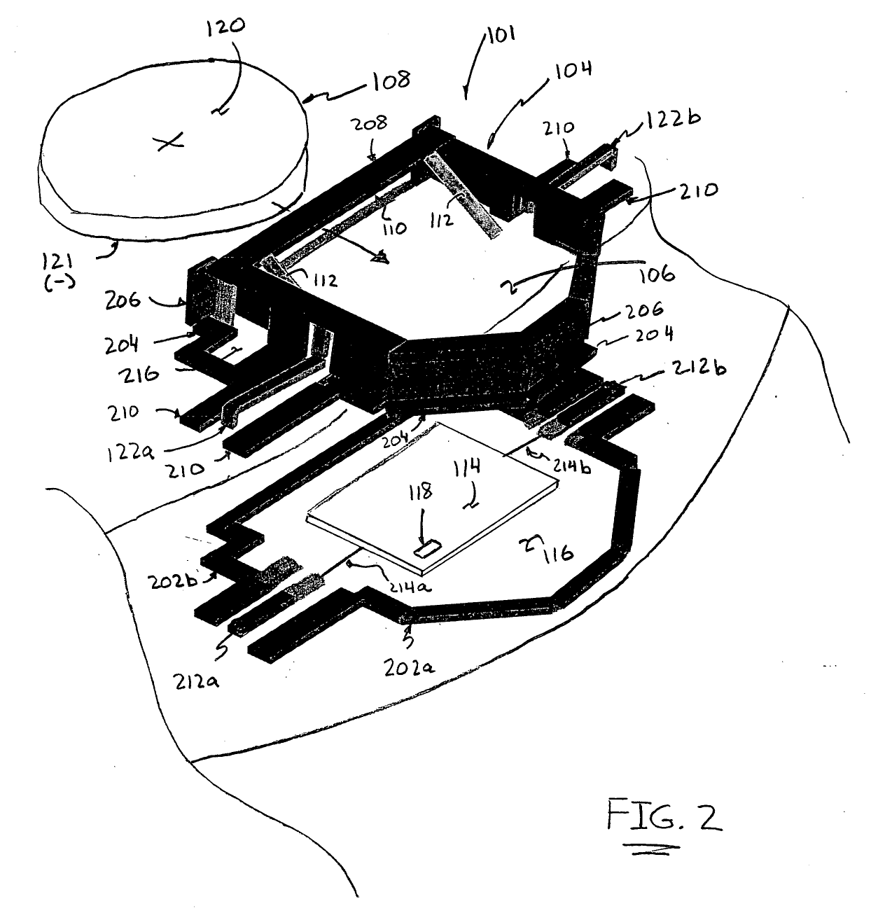

Referring now to the exploded view of FIG. 2, support pads 202a and 202b are coupled to the substrate 102 and are adapted to support the frame 104. The support pads 202a and 202b may be secured to the substrate with an adhesive material. The illustrated support pads 202a and 202b form a pattern on the substrate 102 surface that approximates the same pattern as does a footprint of the frame 104. The support pads 202a and 202b are generally a rigid material, relative to the substrate 102 material, which is usually flexible. Once secured to the substrate 102, the support pads 202a and 202b create localized rigidity in the circuit mounting area 116 of the relatively flexible substrate 102 material. In the illustrated implementation, the circuit mounting area 116 is that area of the substrate 102 surface that is exposed through and substantially surrounded by the support pads 202a and 202b. Accordingly, although the substrate 102 material may be a relatively flexible material, the circuit mounting area 116 of the substrate material tends to resist bending or flexing. Accordingly, the circuit mounting area 116 may be particularly well suited for mounting circuit elements thereto, especially if such circuit elements might be susceptible to damage if they are bent.

When assembled, the frame 104 sits atop the support pads 202a and 202b with each upper surface of the support pads 202a, and 202b contacting a corresponding lower surface of the frame 104. The support pads 202a and 202b thereby provide structural support to the frame 104. A battery 108 can be slid through a battery insertion aperture 110 in the frame 104 and positioned inside a battery holding compartment 106.

The frame 104 includes a substantially flat base 204. A side wall 206 extends from portions of the base 204 in a direction that is substantially perpendicular to a plane of the base. An overhead 208 is coupled to portions of the side wall 206. As mentioned above, the base 204 defines a base footprint that substantially surrounds a circuit mounting area 116 on a surface of the substrate 102. As shown, the circuit mounting area 116, when the frame 104 is coupled to the substrate 102 (via the support pads 202a and 202b), is located beneath the battery holding compartment 106.

According to the illustrated implementation, two pairs of substantially parallel support elements 210 extend from the base 204 in different directions away from the battery receiving compartment 106. Each conductive arm 122a and 122b is adapted to extend from the frame 104 in a direction that is substantially parallel to an associated pair of support elements 210. Each conductive arm 122a and 122b extends, when in a relaxed state, so that it is positioned above and approximately between the associated support elements 210. Each conductive arm 122a and 122b is adapted to flex in a downward direction so that a distal end of the conductive arm 122a and 122b can pass through the associated pair of substantially parallel support elements 210. Accordingly, when a force is applied tending to move one of the conductive arms 122a and 122b downward, the associated pair of substantially parallel support elements tends to counteract the downward force and prevent the frame 104 from becoming dislodged from the support pads 202a and 202b under the applied force.

A pair of conductive pads 212a and 212b are exposed at the upper surface of the substrate 102. Each conductive pad 212a and 212b is positioned between and separated from each support pad 202a and 202b. When the frame 104 is secured to the support pads 202a and 202b, the conductive pads 212a and 212b are positioned beneath a distal end of associated conductive arms 122a and 122b. For example, when the frame 104 is secured to the support pads 202a and 202b, conductive pad 212a is positioned beneath a distal end of conductive arm 122a. Similarly, when frame 104 is secured to the support pads 202a and 202b, conductive pad 212b is positioned beneath a distal end of conductive arm 122b. Accordingly, when either conductive arm 122a or 122b is flexed in a downward direction, the distal end of the flexed conductive arm 122a or 122b contacts the associated conductive pad 212a or 212b.

A collection of circuit elements (indicated by the block labeled 114) are coupled to the circuit mounting area 116 of the substrate 102. In particular instances, other circuit elements may be coupled to the substrate in areas outside the circuit mounting area 116. However, the circuit elements inside the circuit mounting area 116 may be protected from damage that might otherwise result from portions of the substrate 102 bending.

Conductive circuit traces 214a and 214b electrically couple the conductive pads 212a and 212b to the collection of circuit elements. The conductive circuit traces 214a and 214b are adapted to deliver power to one or more of the elements in the collection of circuit elements 114.

The side wall 206 of the frame 104 defines a side wall of the battery holding compartment 106. A portion of the side wall 206 of the frame 104 includes surfaces that define a battery insertion aperture 110, which is adapted to facilitate insertion of a battery into the battery holding compartment 116.

According to the illustrated implementation, each conductive arm 122a and 122b extends from a portion of the overhead 208 in a substantially downward direction for a small distance. Each conductive arm 122a and 122b then bends upward approximately 90° and extends in along a substantially horizontal axis for a longer distance. The distal portion of each conductive arm 122a and 122b is bent approximately 90° downward and extends in that direction for a small distance. Such a configuration may provide favorable bending characteristics to the conductive arms 122a and 122b. Other conductive arm configurations may similarly facilitate the downward movement of such arms under the application of a suitable externally applied downward force. Other suitable configurations might include, for example, conductive arms that are hingedly attached to the frame 104 or attached to the frame with an adhesive material.

The illustrated embodiment also includes a pair of battery retaining tabs 112, each of which extends from a portion of the overhead 208 into the battery holding compartment 106. The battery retaining tabs 112 extend from portions of the overhead that are located above the battery insertion aperture 110. The battery retaining tabs 112 are flexibly coupled to the overhead 208 so that, when a battery 108 is positioned inside the battery holding compartment 106, a distal end of each battery retaining tab 112 touches an upper surface 120 of that battery 108 and urges the battery 108 substantially downward. Such an arrangement may facilitate maintaining electrical connectivity between a negative terminal on the lower surface 121 of the battery 108 and a conductive connection point 118 exposed at a surface of the substrate in the circuit mounting area 116.

A hole 216 is also provided in the frame 104. This hole 216 may allow a light emitting diode (LED), for example, to be viewed during operation of the patch assembly 100. Such an LED might, for example, be adapted to indicate that the device is in operation.

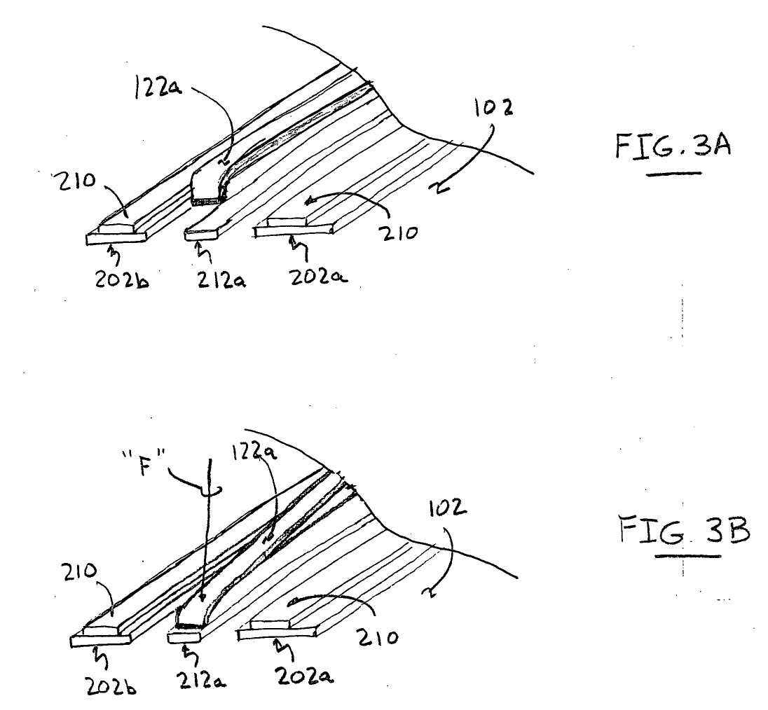

FIGS. 3A and 3B detail the movement of a particular embodiment of a conductive arm 122a under the influence of an externally applied force (indicated in FIG. 3B by the arrow labeled “F”). According to the illustrated implementation, the conductive arm 122a is flexibly coupled to a frame (not shown), and the frame is mounted on support pads 202a and 202b. A pair of substantially parallel support elements 210 extend from the frame (not shown) and are secured to the support pads 202a and 202b. A conductive pad 212a is coupled to the substrate 102 and is positioned beneath the conductive arm 122a. In a relaxed state (FIG. 3A), a space exists between a distal end of the conductive arm 122a and the conductive pad 212a. When the external downward force (indicated by the arrow labeled “F”) is applied (FIG. 3B), the conductive arm 122a flexes downward in such a manner that the distal end of the conductive arm 122a electrically contacts the conductive pad 212a.

In one implementation, the frame 104, the battery retaining tabs 112, the pairs of substantially parallel support elements 210, the conductive arms 122a and 122b, the conductive pads 212a and 212b, and the support pads 202a and 202b are conductive. Each of those components may be, for example, nickel-plated phosphor bronze. Alternatively, each of those components may be, for example, nickel-plated electro-less per military standard mil-C-26074. Other conductive and non-conductive materials may be suitable in various combinations in particular applications.

A number of implementations have been described. Nevertheless, various modifications may be made without departing from the spirit and scope of the invention. For example, numerous conductive arms may be flexibly coupled to a frame that defines a battery holding compartment. Each arm may extend in any direction from the frame. The overall shape of the frame and its underlying support pads may be modified to accommodate various shapes, sizes and numbers of batteries in its battery holding compartment. Various materials or combinations of materials may be suitable for use in manufacturing an apparatus incorporating the various features disclosed herein. For example, although the substrate has been described as a relatively flexible material, more rigid materials may be used as well. In certain instances the substrate may be more rigid than the frame. In such instances, it may be possible to eliminate the support pads. As another example, certain portions of the frame may be manufactured using plastics or other suitable materials.

The shape, size and position of the battery insertion aperture on the frame may be modified. Indeed, other known techniques for inserting a battery into a battery holding compartment may be implemented with the techniques disclosed herein. Additionally, although the discussion above is directed toward a retainer used in a portable PEMF therapy patch assembly, the techniques and concepts disclosed herein can be applied to retainers used with any battery powered devices or products. Indeed, the techniques disclosed herein may be applied in a favorable manner to various battery-powered devices.

Additionally, a certain implementation of the battery retainer may include no switches. Such an implementation may be secured to a flexible substrate to provide a relatively rigid area on the substrate's surface beneath the battery compartment for mounting circuit elements thereto. In such an embodiment, insertion of a battery into the battery compartment may provide physical protection to the circuit elements mounted below it.

Other implementations are within the scope of the following claims.

What is claimed is:

1. An apparatus comprising:
a frame that defines a battery receiving compartment;
a conductive surface exposed on the frame to electrically contact a terminal of a battery in the frame;
a conductive arm movably coupled to the frame and electrically coupled to the conductive surface; and
a conductive pad positioned proximate the conductive arm;
wherein the conductive arm is movable in such a manner as to electrically contact the conductive pad, when so urged.

2. The apparatus of claim 1 wherein the conductive arm is flexibly coupled to the frame and adapted to flex to a position to electrically contact the conductive pad.

3. The apparatus of claim 1 further comprising a support pad positioned below the frame, wherein the frame is coupled to the support pad.

4. The apparatus of claim 3 wherein the support pad is positioned in a same plane as the conductive pad.

5. The apparatus of claim 3 further comprising a substrate, wherein the support pad is coupled to the substrate.

6. The apparatus of claim 5 wherein the substrate is a flexible circuit board and the support pad is substantially rigid relative to the flexible circuit board.

7. The apparatus of claim 5 wherein the support pad is adapted to provide rigidity to a portion of the flexible circuit board that is substantially surrounded by the support pad.

8. The apparatus of claim 5 further comprising a conductive connection point exposed on a surface of the substrate beneath the battery holding compartment, wherein the conductive connection point is adapted to mate with a terminal of a battery that is positioned inside the battery holding compartment.

9. The apparatus of claim 5 wherein the support pad defines a circuit mounting area on the substrate in an area of the substrate that is substantially surrounded by the support pad.

10. The apparatus of claim 9 wherein the battery holding compartment is located substantially above the circuit mounting area.

11. The apparatus of claim 9 further comprising a plurality of circuit elements coupled to the substrate in the circuit mounting area.

12. The apparatus of claim 3 wherein the support pad forms a pattern that approximates a pattern defined by a footprint of the frame.

13. The apparatus of claim 1 wherein the frame is a conductive material and wherein the conductive arm is electrically coupled to the exposed conductive surface through the conductive frame.

14. The apparatus of claim 1 wherein the conductive arm extends from the frame in a direction that is substantially away from the battery holding compartment.

15. The apparatus of claim 1 wherein the frame comprises:
a substantially flat base;
a side wall that extends from portions of the base in a direction that is substantially perpendicular to a plane of the base; and
an overhead coupled to portions of the side wall.

16. The apparatus of claim 15 wherein the base defines a base footprint that, when the frame is coupled to a substrate, substantially surrounds a circuit mounting area on a surface of the substrate.

17. The apparatus of claim 16 wherein the circuit mounting area, when the frame is coupled to the substrate, is located beneath the battery holding compartment.

18. The apparatus of claim 1 further comprising a pair of substantially parallel support elements that extend from the base in a direction substantially away from the battery receiving compartment.

19. The apparatus of claim 18 wherein the conductive arm is movable so that a distal end of the conductive arm is between the pair of substantially parallel support elements, when so urged.

20. The apparatus of claim 15 wherein the side wall defines a side wall of the battery holding compartment.

21. The apparatus of claim 15 wherein a the side wall includes surfaces that define a battery insertion aperture adapted to facilitate insertion of a battery into the battery holding compartment.

22. The apparatus of claim 15 wherein the conductive arm extends from a portion of the overhead.

23. The apparatus of claim 15 wherein the frame further comprises a battery retaining tab that extends from a portion of the overhead into the battery holding compartment.

24. The apparatus of claim 23 wherein the battery retaining tab is flexibly coupled to the portion of the overhead.

25. The apparatus of claim 23 wherein the battery retaining tab is adapted to contact an upper surface of a battery in the battery holding compartment.

26. The apparatus of claim 23 wherein the battery retaining tab is adapted to electrically contact a terminal of a battery positioned inside the battery holding compartment.

27. The apparatus of claim 23 wherein the battery retaining tab is adapted to contact a battery in the battery holding compartment and urge the battery in a substantially downward direction.

28. The apparatus of claim 15 further comprising a plurality of battery retaining tabs, each battery retaining tab extending from a respective portion of the overhead element at least partially into the battery holding compartment, and each battery retaining tab extending in a direction that is parallel to the other battery retaining tabs.

29. The apparatus of claim 1 further comprising:
a plurality of conductive arms coupled to the frame; and
a plurality of conductor pads, each conductive pad exposed at a position proximate an associated one of the conductive arms.

30. The apparatus of claim 29 wherein each conductive arm's position is independently adjustable to electrically contact an associated one of the conductive pads.

31. An apparatus comprising:
a flexible substrate;
a frame coupled to the flexible substrate, the frame defining a battery holding compartment;
one or more circuit elements coupled to the flexible substrate beneath the battery holding compartment;
wherein the one or more circuit elements includes a conductive connection point exposed at a position above the flexible substrate that is higher than other circuit elements.

32. The apparatus of claim 31 wherein the conductive connection point extends at least partially into the battery holding compartment and is adapted to electrically contact a terminal of a battery positioned inside the battery holding compartment.

33. The apparatus of claim 31 wherein the frame is rigid relative to the flexible substrate.

34. The apparatus of claim 31 further comprises a support pad positioned between the frame and the flexible substrate, wherein the support pad is rigid relative to the flexible substrate.

35. The apparatus of claim 34 wherein the one or more circuit elements are coupled to an area of the flexible substrate that is substantially surrounded by the support pad.
